(19) United States
(12) Patent Application Publication
(10) Pub. No.: US 2022/0255167 A1
(43) Pub. Date: Aug. 11, 2022

(54) BATTERY CELL

(71) Applicant: JOHNSON MATTHEY PLC, London (GB)

(72) Inventors: Ashley COOKE, London (GB); Ben LLOYD, London (GB); Sean CLEARY, London (GB); Agata SWIATEK, London (GB); Alan GARDNER, London (GB); Anthony KNIGHT, London (GB)

(21) Appl. No.: 17/595,705

(22) PCT Filed: May 27, 2020
(86) PCT No.: PCT/GB2020/051277

§ 371 Date: Nov. 22, 2021

(30) Foreign Application Priority Data
May 31, 2019 (GB) 1907799.9

(51) Int. Cl. H01M 50/105; H01M 50/186; H01M 50/211; H01M 50/178; H01M 50/264; H01M 50/54

(52) U.S. Cl. CPC H01M 50/105; H01M 50/186; H01M 50/54; H01M 50/178; H01M 50/264; H01M 50/211

(57) ABSTRACT

A battery cell comprising a flexible housing, a first and second electrode, an electrolyte and at least one seal region. The flexible housing includes a perimeter seal at which the housing is sealed around its perimeter. The first and second electrode each comprise a first region and a second region protruding from the first region, wherein the first and second regions of the first and second electrodes are situated within the flexible housing. The electrolyte is situated between the first region of the first electrode and the first region of the second electrode. The first regions of the first and second electrodes and the electrolyte are arranged to define an electrochemical zone housed within the flexible housing. The second regions of the first and second electrodes protrude from the electrochemical zone. The at least one seal region comprises a region in which internal surfaces of the flexible housing are sealed together. The at least one seal region is arranged between the first regions of the first and second electrodes and the perimeter seal and is arranged to inhibit the electrolyte from leaving the electrochemical zone.

### TECHNICAL FIELD

The present disclosure relates to a battery cell and a battery cell arrangement including a battery cell and a clamp. The apparatus disclosed herein may find particular, but not exclusive, application in the field of lithium batteries such as a lithium sulphur battery.

### BACKGROUND

A typical electrochemical cell comprises electrodes, in the form of an anode and a cathode, and an electrolyte disposed between the anode and cathode. The anode, cathode and electrolyte may be contained within a housing. Electrical connections, for example, connection tabs may be coupled to the housing to provide electrical connection with the anode and cathode of the cell and function as terminals of the cell.

A housing of a battery cell may be provided in the form of a flexible housing such as a flexible pouch. A flexible housing may be generally lightweight when compared to rigid housings. A battery cell encased in a flexible housing may therefore find particular application in fields in which the weight of the cell is of importance. For example, battery cells may be used as a power source in vehicles such as land-based vehicles, aircraft and/or spaceborne vehicles. In such applications (and/or other applications) it may be desirable to use relatively lightweight battery cells so as to reduce the total weight of the vehicles and thus battery cells having a flexible housing may be of particular use.

Battery cells having a flexible housing may however be prone to expansion, due to the flexible nature of the housing. This may be of particular concern in applications in which a battery may be exposed to low pressure conditions and/or high temperatures. For example, a battery cell which is used on an aircraft and/or a spaceborne vehicle may be exposed to low pressure conditions when the vehicle is projected to high altitudes.

It is in this context that the subject matter contained in the present application has been devised.

### SUMMARY

According to a first aspect of the present disclosure there is provided a battery cell comprising: a flexible housing including a perimeter seal at which the housing is sealed around its perimeter; a first and second electrode each comprising a first region and a second region protruding from the first region, wherein the first and second regions of the first and second electrodes are situated within the flexible housing; an electrolyte situated between the first region of the first electrode and the first region of the second electrode, wherein the first regions of the first and second electrodes and the electrolyte are arranged to define an electrochemical zone housed within the flexible housing and wherein the second regions of the first and second electrodes protrude from the electrochemical zone; and at least one seal region in which internal surfaces of the flexible housing are sealed together, wherein the at least one seal region is arranged between the first regions of the first and second electrodes and the perimeter seal and is arranged to inhibit the electrolyte from leaving the electrochemical zone.

The at least one seal region may include a seal region arranged between the first regions of the first and second electrodes, the perimeter seal and at least one second region of the first and/or second electrode and the perimeter seal.

The at least one seal region may include a seal region arranged between the second region of the first electrode and the second region of the second electrode.

The at least one seal region may include a seal region arranged between the second region of the first electrode and the perimeter seal.

The at least one seal region may include a seal region arranged between the second region of the second electrode and the perimeter seal.

The at least one seal region may include a seal region arranged within the perimeter seal and within an outer extent of the first and second electrodes.

The perimeter seal may define a sealed boundary.

The at least one seal region may include a seal region arranged within a portion of the sealed boundary in which no electrode is situated.

The second region of the first electrode may be offset from the second region of the second electrode.

The at least one seal region may comprise a sealant arranged in the seal region and attached to opposing internal surfaces of the flexible housing.

The first electrode and second electrode may be substantially planar. The first electrode may be arranged to be substantially parallel with the second electrode.

The battery cell may further comprise a first contact tab electrically coupled to the second region of the first electrode and a second contact tab electrically coupled to the second electrode. The first and second contact tabs may extend through the perimeter seal of the flexible housing.

The at least a portion of first and second tabs may protrude outside of the flexible housing and may comprise electrical terminals of the battery cell.

The battery cell may further comprise a porous separator arranged between the first region of the first electrode and the first region of the second electrode.

The battery cell may comprise a plurality of clamping surfaces arranged to receive a clamping force such that application of a clamping force on the clamping surfaces applies a clamping pressure on the electrochemical zone.

The at least one seal region may be arranged to inhibit the electrolyte from leaving the electrochemical zone when a clamping force is applied to the clamping surfaces.

The at least one seal region may be arranged to form part of at least one of the clamping surfaces.

For example, sealant arranged in a seal region may serve to sufficiently increase the thickness of the cell in the seal region to cause contact between the clamping elements and the flexible housing in the seal region. A clamping force applied to the clamping surfaces may therefore serve to apply a clamping force to at least one of the seal regions. A clamping force applied to at least one seal region may serve to inhibit electrolyte from entering that seal region and/or may serve to inhibit vaporisation of any electrolyte present in that seal region.

According to a second aspect of the present disclosure there is provided a battery cell arrangement comprising: at least one battery cell according to the first aspect; and a clamp arranged to apply a clamping force to clamping surfaces of the at least one battery cell.

The clamp may comprise a first and second clamping element arranged on opposing sides of the at least one battery cell and a clamping device arranged to force the first and second clamping elements to exert a clamping force on the at least one battery cell.

The clamping device may be arranged to retain the first and second clamping elements in fixed relation to each other.

The clamping device may be arranged to urge the first and second clamping elements towards each other.

The clamp may be arranged to apply a uniaxial pressure to the clamping surfaces.

The clamp may be arranged to apply a clamping force sufficient to inhibit vaporisation of the electrolyte.

The clamp may be arranged to apply a clamping pressure which is substantially equal to or greater than a difference between the vapour pressure of the electrolyte and atmospheric pressure to which the battery cell is exposed.

For example, a clamping pressure may be applied which is substantially equal to or greater than a difference between the vapour pressure of the electrolyte down to an atmospheric pressure as low as about 30 mbar. For example, the atmospheric pressure to which the battery cell is exposed may be less than atmospheric pressure at sea level and may for example, be less than about 500 mbar.

In some examples, a clamping pressure may be applied which is substantially equal to or greater than a difference between the vapour pressure of the electrolyte and an atmospheric pressure down to an atmospheric pressure as low as about 5 mbar. For example, the battery cell may in some scenarios be exposed to an atmospheric pressure of less than 30 mbar.

In some examples, a clamping pressure may be applied which is substantially equal to or greater than a difference between the vapour pressure of the electrolyte and an atmospheric pressure which is less than 5 mbar.

In some examples, a clamping pressure may be applied which is substantially equal to or greater than a difference between the vapour pressure of the electrolyte and an atmospheric pressure down to vacuum pressure conditions. For example, the battery cell may be exposed to vacuum pressure conditions (e.g. in spaceborne applications) down to substantially 0 mbar. A clamping pressure may be applied which is sufficient to inhibit vaporisation of the electrolyte even when the battery cell is exposed to vacuum pressure conditions. In such examples, the clamping pressure may be substantially equal to or greater than the vapour pressure of the electrolyte.

References to a vaporisation pressure of an electrolyte may be taken to be the vaporisation pressure of the electrolyte at approximately 20° C. For example, a clamping pressure may be applied which is substantially equal to or greater than a difference between the vapour pressure of the electrolyte at 20° C. and an atmospheric pressure (which may for example, be less than about 500 mbar, less than about 30 mbar, less than about 5 mbar or even as low as substantially a total vacuum) to which the battery cell is exposed.

In some examples, a clamping pressure may be applied which is greater than zero and up to about 10 GPa.

According to a third aspect of the present disclosure there is provided a method for clamping at least one battery cell according to the second aspect, the method comprising: applying a clamping force to the clamping surfaces of the at least one battery cell.

The clamping force may be applied on opposing sides of the at least one battery cell.

Applying the clamping force may comprise applying a uniaxial pressure to the clamping surfaces.

The applied clamping force may be sufficient to inhibit vaporisation of the electrolyte.

The applied clamping force may be such that a clamping pressure applied is substantially equal to or greater than a difference between the vapour pressure of the electrolyte and an atmospheric pressure to which the battery cell is exposed.

For example, a clamping pressure may be applied which is substantially equal to or greater than a difference between the vapour pressure of the electrolyte down to an atmospheric pressure as low as about 30 mbar. For example, the atmospheric pressure to which the battery cell is exposed may be less than atmospheric pressure at sea level and may for example, be less than about 500 mbar.

In some examples, a clamping pressure may be applied which is substantially equal to or greater than a difference between the vapour pressure of the electrolyte and an atmospheric pressure down to an atmospheric pressure as low as about 5 mbar. For example, the battery cell may in some scenarios be exposed to an atmospheric pressure of less than 30 mbar.

In some examples, a clamping pressure may be applied which is substantially equal to or greater than a difference between the vapour pressure of the electrolyte and an atmospheric pressure which is less than 5 mbar.

In some examples, a clamping pressure may be applied which is substantially equal to or greater than a difference between the vapour pressure of the electrolyte and an atmospheric pressure down to vacuum pressure conditions. For example, the battery cell may be exposed to vacuum pressure conditions (e.g. in spaceborne applications) down to substantially 0 mbar. A clamping pressure may be applied which is sufficient to inhibit vaporisation of the electrolyte even when the battery cell is exposed to vacuum pressure conditions. In such examples, the clamping pressure may be substantially equal to or greater than the vapour pressure of the electrolyte.

References to a vaporisation pressure of an electrolyte may be taken to be the vaporisation pressure of the electrolyte at approximately 20° C. For example, a clamping pressure may be applied which is substantially equal to or greater than a difference between the vapour pressure of the electrolyte at 20° C. and an atmospheric pressure (which may for example, be less than about 500 mbar, less than about 30 mbar, less than about 5 mbar or even as low as substantially a total vacuum) to which the battery cell is exposed.

In some examples, a clamping pressure may be applied which is greater than zero and up to about 10 GPa.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all examples and/or features of any example can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE FIGURES

Embodiments of the invention will now be described by way of example only, with reference to the accompanying figures, in which:

FIGS. 1A and 1B are schematic illustrations of a battery cell having a flexible housing;

FIGS. 2A and 2B are schematic illustrations of first and second electrodes which form part of the battery cell of FIGS. 1A and 1B;

FIGS. 3A-3C are schematic illustrations of cross-sectional views of the battery cell of FIGS. 1A and 1B;

FIGS. 4A and 4B are schematic illustrations of battery cell arrangements including a battery cell and a clamp;

FIG. 5 is a schematic illustration of a battery cell including seal regions; and

FIGS. 6A-6C are schematic illustrations of cross-sectional views of the battery cell of FIG. 5.

### DETAILED DESCRIPTION

Before particular examples of the present invention are described, it is to be understood that the present disclosure is not limited to the particular battery cell, battery or method described herein. It is also to be understood that the terminology used herein is used for describing particular examples only and is not intended to limit the scope of the claims.

In describing and claiming the battery cell, batteries and methods of the present invention, the following terminology will be used: the singular forms “a”, “an”, and “the” include plural forms unless the context clearly dictates otherwise. Thus, for example, reference to “a battery cell” includes reference to one or more of such elements.

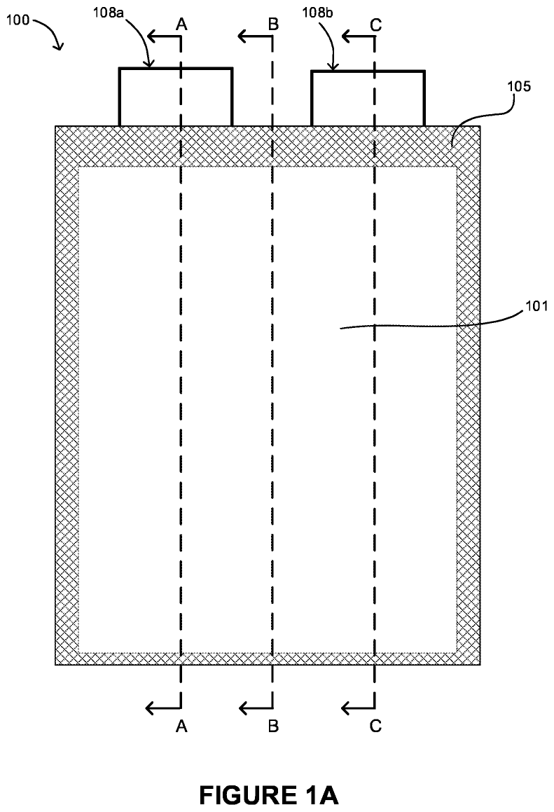

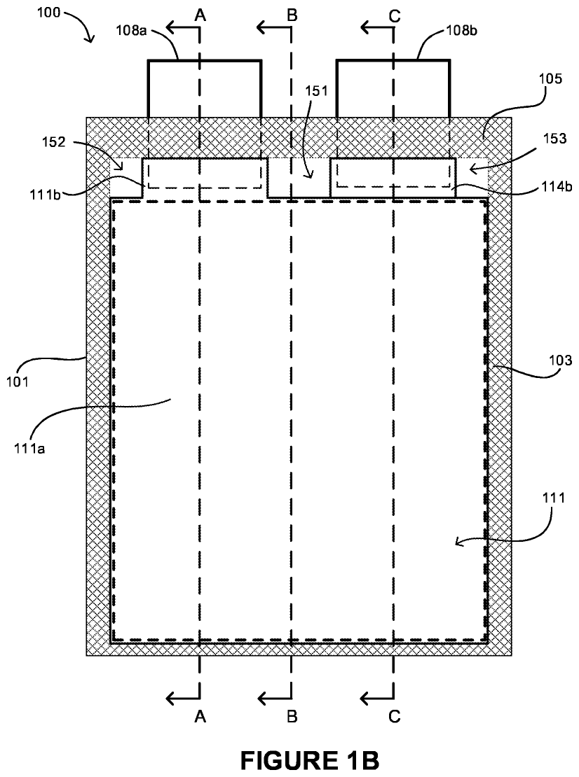

FIG. 1A is a schematic illustration of a battery cell 100 having a flexible housing 101. FIG. 1B is a schematic illustration of a cross-section of the battery cell 100 showing components of the cell 100 situated within the flexible housing 101. The battery cell 100 may comprise any suitable electrochemical cell. For example, the cell may comprise a lithium cell. Suitable lithium cells include lithium-ion, lithium-air, lithium-polymer and lithium-sulphur cells.

The battery cell depicted in FIGS. 1A and 1B is of a pouch type as commonly known in the art. The battery cell 100 comprises a flexible housing 101 (e.g. a pouch), a first electrode 111 and a second electrode 114 (of which only a second region 114b is visible in FIG. 1B) both situated within the flexible housing 101. The battery cell 100 further comprises an electrolyte (not shown in FIGS. 1A and 1B) situated within the flexible housing and between the first and second electrodes 111, 114. The flexible housing 101 is sealed around its perimeter with a perimeter seal 105. The perimeter seal ensures that the housing 100 is sealed such that the electrodes 111, 114 and the electrolyte are sealed within the flexible housing 101.

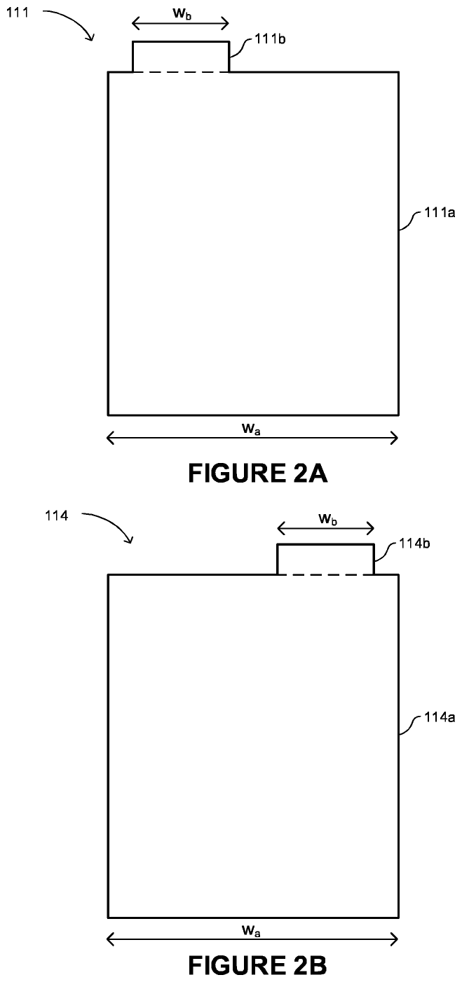

FIGS. 2A and 2B are schematic illustrations of the first 111 and second 114 electrodes respectively. As is shown in FIG. 2A, the first electrode 111 comprises a first region 111a and a second region 111b. Similarly, as shown in FIG. 2B, the second electrode 114 comprises a first region 114a and a second region 114b. The second regions 111b, 114b of the electrodes 111, 114 protrude from the first regions 111a, 114a of the electrodes. As is shown in FIGS. 2A and 2B, the first regions 111a, 114a of the electrodes 111, 114 are generally larger than the second regions 111b, 114b. In particular, a width wₐ of a first region 111a, 114a of electrodes 111, 114 is greater than a width w_{b} of a second region 111b, 114b of the electrodes. That is, the second regions 111b, 114b do not protrude from the first regions 111, 114a across the entire widths wₐ of the first regions 111a, 114a.

Typically the first regions 111a, 114a of the electrodes 111, 114 comprise regions at which electrochemical reactions take place and the second regions 111b, 114b of the electrodes are provided for forming electrical connections with the electrodes. That is, electrical current is usually passed to and from the electrodes through connections formed with the second regions 111b, 114b of the electrodes 111, 114.

One of the electrodes 111, 114 is a cathode and the other of the electrodes 111, 114 is an anode. For example, the first electrode 111 may be a cathode and the second electrode 114 may be an anode, or vice versa. Typically the electrodes 111, 114 comprise at least a conductive substrate (e.g. a current collector). In some examples, an electroactive material may be disposed on all or part of the conductive substrate. For example, a conductive substrate may be formed (e.g. cut from a substrate material) to form both the first 111a, 114a and second 111b, 114b regions of an electrode 111, 114. In some examples, an electroactive material may be deposited on at least part of the conductive substrate. For example, an electroactive material may be deposited on all or part of a first region 111a, 114a of an electrode 111, 114.

The electrodes 111, 114 may be formed of any suitable materials according to the chemistry of the battery cell. In an illustrative example, the battery cell 100 may comprise a lithium sulphur cell. In such an example, a first electrode 111 may be provided in the form of a cathode comprising a current collector on which an electroactive material is disposed. The current collector may, for example, comprise a metal foil such as an aluminium foil. The electroactive material may, for example, comprise an electroactive sulphur material which may, for example, comprise elemental sulphur, Li₂S, sulphur-based organic compounds, sulphur-based inorganic compounds and sulphur-containing polymers.

The electroactive sulphur material may be mixed with an electrically conductive material. The resulting mixture may, for example, be coated onto the current collector as an electroactive matrix. The electrically conductive material may be any suitable material such as a solid material formed of carbon. For example, the electrically conductive material may comprise carbon black, carbon fibre, graphene and/or carbon nanotubes.

The second electrode 114 may be provided in the form of an anode formed from a conductive substrate comprising lithium. For example, the conductive substrate may be formed of a sheet of lithium metal or a lithium metal alloy.

Whilst an illustrative example has been described above in which the battery cell 100 is a lithium sulphur cell, in other examples the battery cell 100 may take a different form and may be formed from other materials. For example, and as was explained above, the battery cell 100 may be any form of cell such as (but not limited to) a lithium-ion, sodium-ion, lithium-air and/or lithium-polymer cell and may correspondingly be formed of any suitable materials (as are known in the art).

As was explained above, the second regions 111b, 114b of the electrodes 111, 114 are typically used for establishing electrical connections with the electrodes 111, 114. Referring again to FIGS. 1A and 1B, the battery 100 further comprises first and second contact tabs 108a, 108b electrically connected to the first 111 and second 114 electrodes respectively. In particular, the contact tabs 108a, 108b are electrically coupled to the second regions 111b, 114b of the electrodes 111, 114. That is, the first contact tab 108a is electrically coupled to the second region 111b of the first electrode 111 and the second contact tab 108b is electrically coupled to the second region 114b of the second electrode 114. The contact tabs 108a, 108b may be coupled to the second regions 111b, 114b of the electrodes using any suitable coupling such as, for example, the use of a conductive adhesive, soldering, riveting, crimping, clamping and/or welding (e.g. ultrasonic or laser welding).

The contact tabs 108a, 108b may be formed of any suitable electrically conductive material. For example, the contact tabs 108a, 108b may be formed of a metal such as aluminium, nickel and/or copper. In some examples, the first and second contact tabs 108a, 108b may comprise different materials. For example, in an illustrative example, the first contact tab 108a may comprise aluminium and the second contact tab 108b may comprise nickel. In an example in which the battery cell 100 comprises a lithium sulphur cell (such as the example described above with reference to the materials used for the electrodes), a first contact tab 108a coupled to a cathode 111 (which may comprise a current collector formed of an aluminium foil) may comprise aluminium. A second contact tab 108b coupled to an anode 114 (which may comprise lithium metal or a lithium metal alloy) may comprise nickel.

As is clearly shown in FIG. 1B, the second regions 111b, 114b of the first and second electrodes 111, 114 are offset from each other. For example, in the perspective shown in FIG. 1B, the first and second electrodes 111, 114 are horizontally offset from each other and separated from each other in the horizontal direction. This offset allows the contact tabs 108a, 108b to be coupled to the first and second electrodes 111, 114 respectively without risking electrical contact between the contact tabs 108a, 108b. Accordingly, the contact tabs 108a, 108b are separated from each other and allow independent electrical connections to be established to the first 111 and second electrodes 114. For example, as is shown in FIGS. 1A and 1B, the contact tabs 108a, 108b protrude from the flexible housing 101 and allow external connections to be established with the battery cell 101. The contact tabs 108a, 108b therefore function as terminals of the battery cell 101.

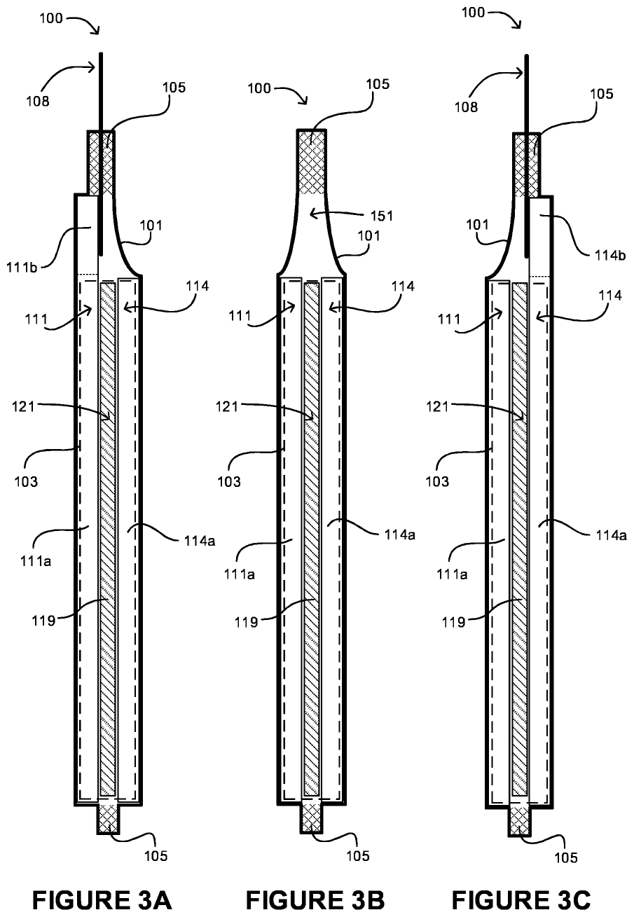

FIGS. 3A, 3B and 3C are schematic illustrations of cross-sectional views of the battery cell 100 of FIGS. 1A and 1B. The cross-section shown in FIG. 3A is taken along the line A-A indicated in FIGS. 1A and 1B. The cross-section shown in FIG. 3B is taken along the line B-B indicated in FIGS. 1A and 1B. The cross-section shown in FIG. 3C is taken along the line C-C indicated in FIGS. 1A and 1B. It will be appreciated that the components shown in FIGS. 3A-3C (as well as the other Figures) are not shown to scale. For example, at least some of the dimensions of one or more of the components shown in the Figures may be enlarged or contracted for ease of illustration.

As is shown in FIGS. 3A-3C a separator 119 is provided between the first 111 and second 114 electrodes. In particular, the separator 119 is arranged to prevent electrical contact between the first electrode 111 and the second electrode 114. As was mentioned above, the battery cell 100 further comprises an electrolyte situated within the flexible housing 101 and between the first 111 and second electrodes 114. The separator 119 may comprise a porous substrate, which allows ions to move between the first and second electrodes 111, 114. The electrolyte may therefore be situated within the separator 119 and is denoted generally with the arrow labelled 121 in FIGS. 3A-3C.

The separator 119 may have a porosity of greater than about 30%. For example, the porosity of the separator 119 may be greater than about 50% or even greater than about 60%. A suitable separator 119 may, for example, include a mesh formed of a polymeric material. Suitable polymers include polypropylene, nylon and polyethylene.

Any suitable electrolyte 121 may be used. The electrolyte 121 may comprise an organic solvent and a lithium salt. Suitable organic solvents include ethers, esters, amide, amine, sulfoxides, sulfamides, organophosphates, ionic liquids, carbonates and sulfones. Examples include ethylene carbonate, dimethyl carbonate, tetrahydrofuran, 2-methyltetrahydrofuran, methylpropylpropionate, ethylpropylpropionate, methyl acetate, 1,2-dimethoxyethane, 1,3-dioxolane, diglyme (2-methoxyethyl ether), triglyme, tetraglyme, butyrolactone, 1,4-dioxane, 1,3-dioxane, hexamethyl phosphoamide, pyridine, dimethyl sulfoxide, tributyl phosphate, trimethyl phosphate, N, N, N, N-tetraethyl sulfamide, and sulfones and their mixtures.

Suitable electrolyte salts include lithium salts. Suitable lithium salts include lithium hexafluorophosphate, lithium hexafluoroarsenate, lithium nitrate, lithium perchlorate, lithium trifluoromethanesulfonimide, Lithium bis(trifluoromethanesulfonyl)imide, lithium bis(oxalate) borate and lithium trifluoromethanesulphonate. In some examples, combinations of salts may be employed. For example, lithium triflate may be used in combination with lithium nitrate. The lithium salt may be present in the electrolyte at a concentration of 0.1 to 5M, preferably, 0.5 to 3M.

As will be well understood, during operation of the battery cell (e.g. charging and/or discharging of the cell) ions in the electrolyte travel between the electrodes and electrochemical reactions occur at the electrodes 111, 114. The first and second electrodes 111, 114 and the electrolyte therefore define an electrochemical zone 103 in which electrochemical reactions take place during operation of the battery cell 100. As was described above, typically, the electrolyte 121 is situated between the first 111a, 114a regions of the electrodes 111, 114. Furthermore, in at least some examples, electroactive material of the first and/or second electrodes 111, 114 may be restricted to the first regions 111a, 114a of the electrodes 111, 114 and may be absent from the second regions 111b, 114b. The second regions 111b, 114b of the electrodes may therefore be situated outside of the electrochemical zone 103. That is, the second regions 111b, 114b of the electrodes 111, 114 protrude from the electrochemical zone 103.

As was explained above, the flexible housing 101 is sealed around its perimeter by way of a perimeter seal 105. The flexible housing 101 is therefore a sealed housing which contains the electrolyte 121 and the electrodes 111, 114 and protects those components from the external environment. The sealing of the flexible housing 101 may be considered to form a sealed pouch. The flexible housing 101 may be formed of a composite of materials, for example, of a metal and a polymer. For example, the flexible housing 101 may comprise aluminium laminated with a polymer (e.g. polypropylene formed on the interior of the flexible housing and nylon formed on the exterior of the flexible housing).

As can be seen from the examples shown in the Figures, the battery cell 100 may generally be of a planar shape. For example, the battery cell may be of a generally rectangular shape. In such examples, the flexible housing 101 may be formed from opposing sheets of flexible material which are sealed around their perimeter. For example, two portions of flexible material may be placed either side of the electrodes 111, 114 and may be sealed together around the perimeter of the electrodes 111, 114 so as to form a housing in which the electrodes 111, 114 are sealed.

As was explained above, the perimeter seal 105 may be formed by sealing surfaces of a flexible material together so as to form a housing 101. The perimeter seal 105 may be formed around at least part of the perimeter of the flexible housing 10. The perimeter seal 105 may, for example, be formed by sealing material together using any suitable technique such as heat treatment, heat sealing and/or using an adhesive/bonding material.

As was explained above, the first and second electrodes 111, 114 and the electrolyte 121 may be completely enclosed within the flexible housing 101 by the perimeter seal 105 such that they are isolated from an atmosphere surrounding the battery cell 100. For example, the second regions 111b, 114b of the electrodes 111, 114 may protrude from the electrochemical zone 103 but are contained within (i.e. do not protrude from) the flexible housing 101.

In the depicted examples, the perimeter seal 105 is formed around an outer extent of the electrodes 111, 114. For example, the perimeter seal 105 may be formed substantially around a perimeter of the smallest rectangle enclosing both the first regions 111a, 114a and second regions 111b, 114b of the first 111 and second 114 electrodes (herein referred to as the outer extent of the electrodes). The perimeter seal 105 can be considered to seal the perimeter of the flexible housing 101. For example, the perimeter seal 105 may generally be situated in a region between the outer extent of the electrodes 111, 114 and an outer edge of the flexible housing 101.

In the depicted example, the perimeter seal 105 is formed by sealing material together around the entire perimeter of the flexible housing 101. However, in some examples, it may be possible to form a sealed flexible housing 101 without sealing the material forming the housing around its entire perimeter. For example, the flexible housing 101 may be formed of a single sheet of flexible material which is bent around one edge of the electrodes 111, 114 so as to form a first portion of the sheet of material on one side of the electrodes 111, 114 and a second portion of the sheet of material on an opposing side of the electrodes 111, 114. The first and second portions of the flexible material may then be sealed together around the remaining three edges of the electrodes so as to form a sealed housing in which the electrodes 111, 114 are situated. In such an example, the housing 101 may still be considered to comprise a perimeter seal 105 at which the housing 101 is sealed around its perimeter, where a portion of the perimeter seal 105 is formed by continuation of the housing material itself (e.g. at an edge where the material is folded around the electrodes 111, 114).

Whilst examples have been described above in which a battery cell 100 includes a first electrode 111 and a second electrode 114, in some examples a battery cell 100 may comprise more than two electrodes. For example, a battery cell 100 may comprise a plurality of electrodes 111 which function as a cathode and a plurality of electrodes 114 which function as an anode. In some examples, a plurality of cathodes and a plurality of anodes may be arranged as a stack. For example, a plurality of cathodes and a plurality of anodes may be arranged in an alternating fashion. That is, each alternate electrode in a stack may be a cathode with an anode situated in between each cathode. An arrangement including more than two electrodes may include an electrode functioning as a cathode situated in between two electrodes functioning as an anode and an electrode functioning as an anode situated in between two electrodes functioning as a cathode. As was explained above, a separator 121 may be situated in between adjacent electrodes in order to provide electrical isolation between adjacent electrodes. For example, each pair of adjacent electrodes may be provided with a separator 121 situated in between them. The electrolyte 121 may be provided between each pair of electrodes.

In an arrangement including more than two electrodes, a plurality of electrodes of a similar type may be electrically connected to each other. For example, a plurality of electrodes functioning as cathodes may be electrically connected to each other. Similarly, a plurality of electrodes functioning as anodes may be electrically connected to each other. Electrodes may be electrically connected to each other by electrically connecting second regions 111b, 114b of the electrodes together. For example, second regions 111b of a plurality of electrodes functioning as cathodes may be brought into contact with each other. Similarly, second regions 114b of a plurality of electrodes functioning as anodes 114b may be brought into contact with each other.

As was explained above, the second region 111b of a first electrode 111 may be offset from the second region 114b of a second electrode 114. In some examples, a plurality of electrodes in the form of the first electrode 111 described above may be provided to function as cathodes. Similarly, a plurality of electrodes in the form of the second electrode 114 described above may be provided to function as anodes. That is, a plurality of electrodes 111 functioning as cathodes 111 may include second regions 111b which are substantially aligned with each other. A plurality of electrodes 114 functioning as anodes 114 may include second regions 114b which are substantially aligned with each other but which are offset and separated from the second regions 111b of the cathodes 111. This may allow the second regions 111b of the cathodes 111 to be connected to each other and the second regions 114b of the anodes 114 to be connected to each other whilst maintaining electrical isolation between the cathodes 111 and the anodes 114. A first contact tab 108a may be electrically connected to the second regions 111b of the cathodes 111 and a second contact tab 108b may be electrically connected to the second regions 114b of the anodes 114 so as to provide terminals of the battery cell.

As was explained above, a battery cell 100 of the type described above may include a first electrode 111 and a second electrode 114 or may include a plurality of first electrodes 111 and a plurality of second electrodes 114. It will be appreciated that any description and teachings provided herein with reference to a battery cell 100 comprising a first electrode 111 and a second electrode 114 may also apply to a battery cell comprising a plurality of first electrodes 111 and a plurality of second electrodes 114 and vice versa.

As was explained above, the housing 100 in which the electrodes 111, 114 and the electrolyte 121 are contained is sealed and flexible. The flexible housing 101 may therefore be prone to expansion. Significant expansion of the housing is generally undesirable as it places a strain on the housing 101 and may risk damage to, leakage and/or rupture of the housing 101. Furthermore, expansion of the flexible housing may be undesirable when a cell is situated in close proximity to other components. For example, in some applications a plurality of cells may be situated adjacent to each other (e.g. in a stack of cells). In such an arrangement, substantial expansion of one or more of the cells may cause adjacent cells to come into contact with other and to exert pressure on each other.

Expansion of a battery cell 100 may be a particular concern in applications in which one or more battery cells are exposed to pressure conditions which are lower than atmospheric pressure at sea level. For example, battery cells 100 of the type described above may find applications in aircraft and/or spacecraft, which are flown at altitudes at which the ambient pressure is significantly lower than atmospheric pressure at sea level, for example, in the case of a spacecraft the ambient pressure may be close to or at a total vacuum. Exposure to low pressure conditions (e.g. when flying an aircraft at high altitude) may cause some expansion of the flexible housing 101.

Expansion of the flexible housing 101 may be a particular problem in situations in which the ambient pressure is close to or lower than a vaporisation pressure of the electrolyte 121. The flexible nature of the housing 101 may mean that if a battery cell 101 is unconfined, the pressure inside of the housing 101 may be approximately the same as the pressure of the atmosphere immediately surrounding the housing 101. If the pressure of the atmosphere immediately surrounding the housing 101 is close to or less than the vaporisation pressure of the electrolyte 121, then the electrolyte 121 may vaporise and thus significantly expand. It will be appreciated that vaporisation and expansion of the electrolyte 121 may cause significant expansion of the flexible housing 101.

The risk of vaporisation of the electrolyte 121 when operated at low ambient pressures may be particularly relevant for battery cells 100 in which the electrolyte has a relatively high vaporisation pressure. For example, a lithium sulphur battery may utilise an electrolyte having a relatively high vaporisation pressure when compared to other battery chemistries. For example, the vaporisation pressure of a typical electrolyte used in a lithium sulphur battery may be higher than the vaporisation pressure of a typical electrolyte used in a lithium ion battery.

For example, a typical operation temperature of a battery cell may be approximately 20° C. In a purely illustrative example, an electrolyte comprising 1,2-dimethoxyethane may be used in a lithium sulphur battery. An electrolyte comprising 1,2-dimethoxyethane may have a vaporisation pressure of approximately 48 mmHg (at 20° C.). To provide another example, an electrolyte comprising 1,3-dioxolane may be used in a lithium sulphur battery. An electrolyte comprising 1,3-dioxolane may have a vaporisation pressure of approximately 70 mmHg (at 20° C.).

In contrast to electrolytes used in a lithium sulphur battery, an example of an electrolyte for use in a lithium ion battery may comprise dimethyl carbonate. Dimethyl carbonate which may have a vaporisation pressure of approximately 18 mmHg (at 21.1° C.). Other examples of electrolytes for use in a lithium ion battery include diethyl carbonate which has a vaporisation pressure of approximately 10 mmHg (at 23.8° C.), propylene carbonate which has a vaporisation pressure of 0.13 mmHg (at 20° C.) or ethylene carbonate which has a vaporisation pressure of 0.02 mmHg (at 36.4° C.).

In general, electrolytes of a type commonly used in a lithium sulphur battery may therefore have a vaporisation pressure which be higher than a vaporisation pressure of electrolytes commonly used in a lithium ion battery. A lithium sulphur battery may therefore be more at risk of vaporisation of the electrolyte when operated at low pressures than a lithium ion battery.

In addition to or alternatively to operation at low ambient pressures, a battery cell 100 may be operated at relatively high temperatures. The vaporisation pressure of an electrolyte is typically a function of temperature and generally increases with increasing temperature. Operation of a battery cell 100 at relatively high temperatures may therefore involve operating the battery cell 100 whilst the vaporisation pressure of the electrolyte 121 is relatively high. Operation at relatively high temperatures may therefore increase the risk of vaporisation of the electrolyte 121 even at atmospheric pressures. As described in relation to the low pressure operation of the battery cell, high temperatures may similarly lead to vaporisation of the electrolyte and subsequent undesirable expansion of the flexible housing. Any teachings presented herein with reference to operation of a battery at low pressures may equally apply to operation of a battery at high temperatures.

As was described above, a battery cell 100 of the type described above and contained within a flexible housing 101 may be prone to expansion of the flexible housing 101. This may in particular be the case where the battery is to be exposed to ambient pressure conditions which are close to or less than the vaporisation pressure of the electrolyte used in the battery cell 100. Additionally or alternatively, this may be the case where the battery is exposed to relatively high temperatures.

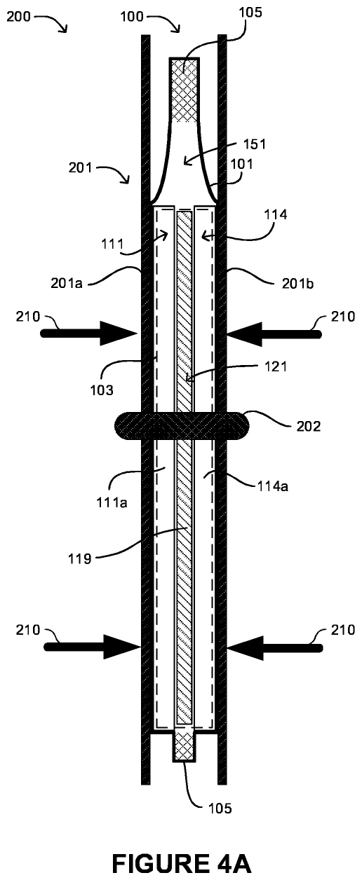

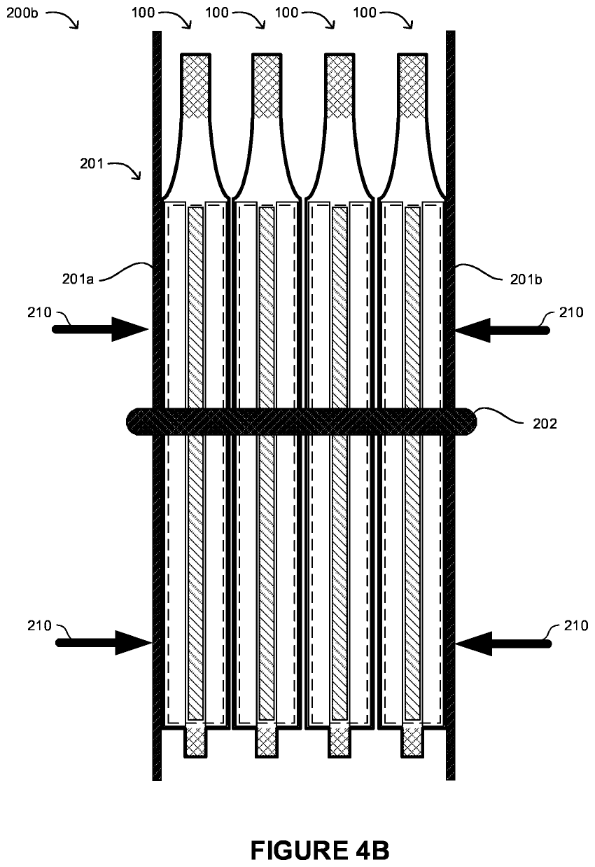

According to examples of the present disclosure, expansion of a flexible housing 101 of a battery cell may be reduced or mitigated by applying pressure to the battery cell 100. For example, a clamping pressure may be applied to a battery cell 100 having a flexible housing 101 in order to increase the pressure inside of the housing 101. FIG. 4A is a schematic illustration of a battery cell arrangement 200 according to an example of the present disclosure comprising a battery cell 100 and a clamp 201 arranged to apply a clamping force to the battery cell 100. The battery cell 100 is generally of the form described above and depicted in FIGS. 1-3. The same reference numerals have been used in FIG. 4A to denote corresponding components to those described above in connection with FIGS. 1-3. No detailed explanation of the components of the battery cell 100 is therefore provided with reference to FIG. 4A. The depiction shown in FIG. 4A provides a cross-sectional view of the battery cell 100 which is equivalent to the cross-section B-B which is shown in FIG. 3B.

In the example, depicted in FIG. 4A, the clamp 201 is provided in the form of a first clamping element 201a, a second clamping element 201b and a clamping device 202. The first and second clamping elements 201a, 201b are generally rigid structures and may be provided, for example, in the form of rigid plates 201a, 201b. The clamping elements 201a, 201b may be constructed from any suitable material such as, for example, a carbon fibre.

The clamping device 202 is arranged to retain the clamping elements 201a, 201b such that under at least some conditions, the clamping elements 201a, 201b exert a clamping force on the battery cell 100. The clamping device 202 may be provided in any suitable form such as, for example, one or more flexible straps, springs and or rigid elements in contact with both the first and second clamping elements 201a, 201b. In the depiction of FIG. 4A, the clamping device 202 is provided in the form of a single element arranged to clamp the first and second elements 201a, 201b together. In some examples, the clamping device 202 may comprise a plurality of such elements.

A battery cell 100 of the type described herein may be provided with a plurality of clamping surfaces arranged to receive a clamping force. For example, the shape of the battery cell 100 may be such that it includes opposing clamping surfaces on which a clamping force may be applied such that application of a clamping force on the clamping surfaces applies a clamping pressure on the electrochemical zone 103. As was explained above, a battery cell 100 of the type described herein may be provided in the form of a generally planar shape. In such an example, the opposing faces of the generally planar shape may function as clamping surfaces on which a clamping force may be applied.

The clamping elements 201a, 201b may have dimensions which are substantially equal to or greater than equivalent dimensions of clamping surfaces of the battery cell 100. For example, a width and/or height of the clamping elements 201a, 201b may be substantially equal to or greater than a corresponding width and/or height of clamping surfaces of the battery cell 100. This may allow a clamping force to be applied across the majority of or all of a clamping surface of the battery cell 101 and may limit any regions which the battery cell 101 might be allowed to expand into.

In the example shown in FIG. 4A, the clamping elements 201a, 201b are arranged either side of the battery cell 100 and adjacent to clamping surfaces of the cell 100. The clamping elements 201a, 201b may apply a clamping force to the clamping surfaces so as to exert a clamping pressure on the electrochemical zone 103 of the cell 100. The general direction of the clamping force is indicated by the arrows denoted with the reference numeral 210 in FIG. 4A and may exert a uniaxial clamping pressure.

In some examples, the clamping device 202 may be arranged to clamp the clamping elements 201a, 201b and apply a clamping force to the battery cell 100 even when the battery cell 100 is not prone to expansion. For example, the clamp 201 may apply a clamping force to the battery cell 100 under atmospheric conditions at sea level. In such examples, the clamping device 202 may be arranged with a pre-strain. For example, the clamping device 202 may comprise one or more tensioned straps and/or springs.

In other examples, the clamping device 202 may be arranged without a pre-strain such that the clamping elements 201a, 201b do not apply a substantial clamping force on the battery cell 100 in the absence of any expansion of the battery cell 100. For example, the clamping device 202 may be arranged to hold the clamping elements 201a, 201b in substantially fixed relation to each other. In such an arrangement the clamping elements 201a, 201b may be arranged in contact with or closely adjacent to the battery cell 100. If the battery cell 100 begins to undergo expansion (e.g. due to a decrease in ambient pressure and/or increase in temperature) clamping surfaces of the battery cell may exert an expansion force on the clamping elements 201a, 201b. Since the clamping elements 201a, 201b are held in substantially fixed relation to each other the expansion force of the battery cell 100 results in a clamping force being applied to the battery cell 100, which applies a clamping pressure to the electrochemical zone 103.

The clamp 201 may be arranged to apply a clamping pressure to the battery cell 100, and in particular to the electrochemical zone 103, which is sufficient to prevent, or at least inhibit, vaporisation of the electrolyte 121 in all pressure conditions in which the battery cell 100 is configured to operate. For example, the clamp 201 may be arranged to apply a clamping pressure P_{c} given by P_{c}≥Pᵥ−Pₘᵢₙ, where P_{V} is the vapour pressure of the electrolyte 121 and Pₘᵢₙ is the minimum atmospheric pressure at which the battery cell 100 is to be operated. For example, a battery cell may be able to operate from atmospheric pressure down to pressures of approximately 30 mbar or less. In some examples, a battery cell may be operated at even lower pressures such as approximately <5 mbar or less and may even be operated at pressures close to or at a total vacuum.

A clamping pressure which may be applied to battery cell may, for example, be provided in the form of a fixed volume clamp, which for example does not actively apply a pressure to the battery cell but merely inhibits expansion of the cell by limiting the volume of the cell. Alternatively a non-zero clamping pressure may be applied to a battery cell. For example, a clamping pressure of greater than zero and up to about 10 GPa may be applied to a battery cell.

Whilst an example, has been described above and depicted in FIG. 4A in which a clamp 201 is arranged to apply a clamping force to a single battery cell 100, in some examples a clamp 201 may be arranged to apply a clamping force to a plurality of battery cells 100. FIG. 4B is a schematic illustration of a battery cell arrangement 200b according to an example of the present disclosure comprising a plurality of battery cells 100 and a clamp 201 arranged to apply a clamping force to the plurality of battery cells 100. In the example shown in FIG. 4B a plurality of battery cells 101 are positioned in close proximity to each other (e.g. in a stack of battery cells 101) and/or in contact with each other. A clamp 201 is arranged to apply a clamping force to the plurality of battery cells 101. For example, the clamp 201 is arranged around the stack of battery cells 101. The clamp 201 may be similar to or the same as the clamp 201 described above with reference to FIG. 4A. For example, any of the features described above with reference to a clamp 201 arranged to clamp a single battery cell may equally apply to a clamp 201 arranged to clamp 201 a plurality of battery cells 101.

Any description and teachings presented herein with reference to clamping of a single battery cell 101 may also apply to examples in which a clamp 201 is arranged to apply a clamping force to a plurality of battery cells 101 and vice versa.

As was explained above, application of a clamping force to a battery cell 100 may prevent or at least inhibit expansion of a flexible housing 101 of the battery cell 100. This may, for example, allow the battery cell 100 to be operated under low pressure conditions and may reduce the risk of damage to the battery cell 100 or surrounding components when exposed to low atmospheric pressure conditions. In particular, an example was described above in which a clamping pressure is applied to the electrochemical zone 103. For example, as can be seen in FIG. 4A, the clamping elements 201a, 201b are arranged in contact with clamping surfaces of the battery cell 101, which approximately correspond to the size and shape of the first regions 111a, 114a of the electrodes 111, 114. A clamping force is therefore applied in a region corresponding to the first regions 111a, 114a of the electrodes 111, 114. Consequently, a clamping pressure is applied to the electrochemical zone 103 and to the electrolyte 121 situated in the electrochemical zone 103.

Furthermore, the application of a clamping force to a battery cell 100 may prevent or inhibit expansion of a flexible housing 101 of the battery cell 100 when the battery cell 100 is operated under high temperature conditions. The clamping force may reduce the risk of damage to the battery cell 100 or surrounding components when exposed to high temperature conditions. As was explained above, at constant pressure, high temperature conditions may cause the vaporisation pressure of the electrolyte to increase, such that the vapor pressure may become comparable to the atmospheric pressure of the cell, even at atmospheric pressures. This may result in vaporisation of the electrolyte 121 without decreasing the external pressure of the battery cell 100.

Whilst a clamping pressure may be applied to the electrolyte 121 situated in the electrochemical zone 103 (in between the first regions 111a, 114a of the electrodes 111, 114), in some arrangements there may be regions of the battery cell 100 in which little or no clamping pressure is applied. For instance, in the example illustrated in FIG. 4A there is a first expansion region labelled 151, in which the flexible housing 101 is not in contact with the clamping elements 201a, 201b. Consequently, little or no clamping pressure may be applied to the first expansion region 151. If the battery cell 101 shown in FIGS. 1-4 is operated at low pressure conditions the pressure in the first expansion region 151 may therefore decrease along with the ambient pressure conditions to which the battery cell 100 is exposed (in the absence of a clamping pressure in this region). For example, whilst the electrochemical zone 103 is maintained at a higher pressure due to the application of a clamping force, the pressure in the first expansion region 151 may decrease below the pressure in the electrochemical zone 103.

Consequently, some electrolyte 121 may be drawn out of the electrochemical zone 103 and into the first expansion region 151 (or may already be present in the first region 151) and may vaporise if the pressure in the first expansion region 151 reaches or decreases below the vaporisation pressure of the electrolyte 121. As was explained above, if the electrolyte 121 vaporises it generally expands and may cause expansion of the flexible housing 101.

In the example shown in FIG. 4A, if the battery cell 100 is operated at pressure conditions close to or less than a vaporisation pressure of the electrolyte 121, the flexible housing 101 may therefore be forced to expand in any regions (e.g. the first expansion region 151) in which the electrolyte 121 may be situated and which is not subjected to a clamping pressure. As was explained above, expansion of the flexible housing 101 is generally undesirable as it may strain the flexible housing 101 and may cause damage to the flexible housing 101. For example, expansion of the flexible housing 101 may cause the flexible housing 101 to rupture.

Whilst the disadvantages of vaporisation of the electrolyte 121 have been described above in the context of expansion of the flexible housing 101, vaporisation of the electrolyte 121 may also have detrimental effects on the performance of the battery cell 100. For example, vaporised electrolyte 121 and electrolyte 121 which is not situated in the electrochemical zone 103 is generally not available for performing its role within the electrochemical cell. For example, vaporised electrolyte will not be available to contribute to the formation of a solid-electrolyte-interface (SEI) at the surface of lithium anodes contained in lithium-metal cells. Vaporisation of the electrolyte 121 may therefore generally degrade the cyclability of the battery cell 100.

An example has been described above in which the flexible housing 101 is prone to expansion in a first expansion region 151 situated in between the second region 111b of the first electrode 111 and the second region 114b of the second electrode 114. In general, the flexible housing 101 may be prone to expansion in any region in which the pressure inside the housing 101 is allowed to decrease in correspondence to a decrease in the atmospheric pressure in which the battery cell 100 is held. For example, expansion of the flexible housing 101 may occur in regions which are not subjected to a clamping pressure.

In addition to the first expansion region 151 described above and depicted in FIG. 4A (also labelled in FIGS. 1 and 3B) a battery cell 100 may include additional expansion regions in which the flexible housing 101 may expand when exposed to low atmospheric pressure conditions. For example, as is labelled in FIG. 1B there may be a second expansion region 152 and/or a third expansion region 153 which may not be subjected to a clamping pressure. For corresponding reasons to those described above with reference to the first expansion region 151, the second 152 and/or third expansion 153 regions may be prone to expansion if the battery cell 101 is exposed to low atmospheric pressure conditions.

Expansion regions 151, 152, 153 may be present in regions of the battery cell 100 in which the thickness of the battery cell 100 is less than a maximum thickness of the battery cell 100 (i.e. the maximum thickness in other regions of the battery cell 100). For example, the first 151, second 152 and third 153 expansion regions are located in regions in which there is no portion of the first 111 or second 114 electrode present. For instance the first expansion region 151 is situated in a gap between the second region 111b of the first electrode 111 and the second region 114b of the second electrode 114. The second expansion region 152 is situated in a gap between the second portion 111b of the first electrode 111 and the perimeter seal 105. The third expansion region 153 is situated in a gap between the second portion 114b of the second electrode and the perimeter seal 105.

Since there is no portion of electrodes 111, 114 situated in the expansion regions 151, 152, 153, the thickness of the battery cell 100 in the expansion regions 151, 152, 153 is generally smaller than the thickness in other regions of the battery cell 100. For example, the thickness of the battery cell 100 in the expansion regions 151, 152, 153 is generally smaller than the thickness of the battery cell 100 in the electrochemical zone 103. Furthermore, the thickness of the expansion regions 151, 152, 153 may generally be smaller than the thickness in the regions occupied by the second regions 111b, 114b of the electrodes 111, 114.

As is demonstrated in FIG. 4A, in regions, such as the first expansion region 151 (and similarly the second 152 and third 153 expansion regions) in which the thickness of the battery cell 100 is less than a maximum thickness of the cell, the flexible housing 101 may not be in contact with the clamping elements 201a, 201b. Consequently, little or no clamping pressure is applied in the expansion regions 151, 152, 153 and thus the flexible housing 101 in these regions may be free to expand.

The expansion regions 151, 152, 153 are also regions inside the perimeter seal 105 and thus are not held together by the perimeter seal 105. Each of the expansion regions 151, 152, 153 are located in between the first portions 111a, 114a of the electrodes 111, 114 and the perimeter seal 105. As can be seen for example in FIGS. 1, 3A-3C and 4A, the perimeter seal 105 is outside of the extent of the second regions 111b, 114b of the electrodes 111, 114. For instance, in the orientations shown in the Figures, the perimeter seal 105 is situated above the upper extent of the second regions 111b, 114b of the electrodes 111, 114. This may be because it is generally desirable to keep the second regions 111b, 114b of the electrodes 111, 114 sealed within the housing 101, for example, to prevent the electrodes 111, 114 from coming into contact with the surrounding atmosphere.

Furthermore, it may not be possible to form a seal directly with the second regions 111b, 114b of the electrodes 111, 114. For example, it may not be possible to seal the flexible housing 101 directly to a second regions 111b, 114b of an electrode 111, 114. For instance an electrodes 111, 114, formed of lithium may be highly reactive and may catch fire if an attempt to form a seal between such an electrode and the flexible housing 101 were to be made.

As was explained above, the construction of a battery cell 100 having a flexible housing 101 may include regions which are prone to expansion when operated at low pressures. Such regions may be prone to expansion even in the presence of a clamping force applied to the battery cell 100.

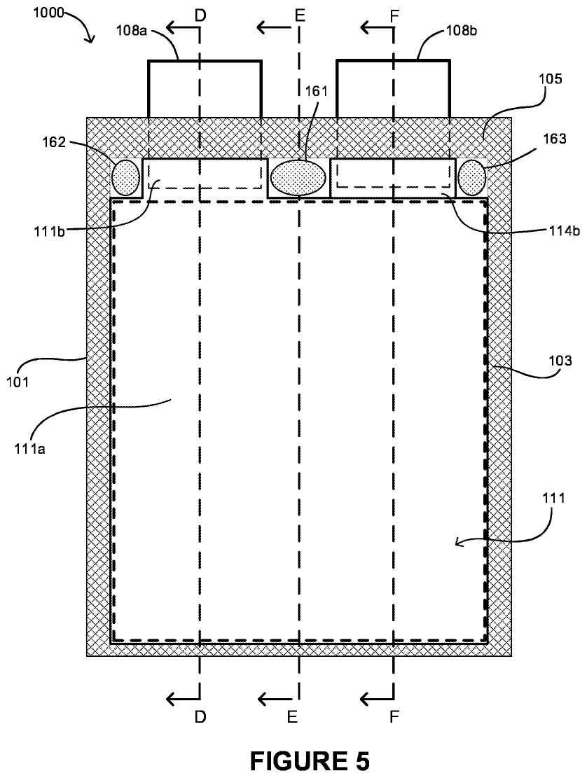

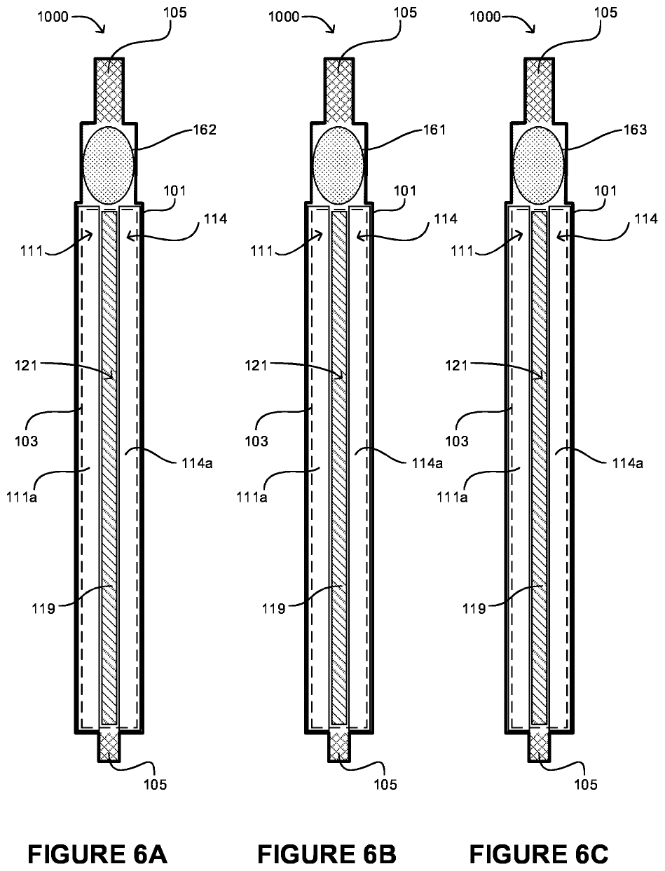

FIG. 5 is a schematic illustration of a battery cell 1000 according to an example of the present disclosure. FIGS. 6A, 6B and 6C are schematic illustrations of cross-sectional views of the battery cell 1000 of FIG. 5. The cross-section shown in FIG. 6A is taken along the line D-D indicated in FIG. 5. The cross-section shown in FIG. 6B is taken along the line E-E indicated in FIG. 5. The cross-section shown in FIG. 6C is taken along the line F-F indicated in FIG. 5.

The battery cell 1000 shown in FIGS. 5 and 6A-6C includes many of the same or corresponding components to the battery cell 100 which was described above with reference to FIGS. 1-4. The same reference numerals have been used in FIGS. 5 and 6A-6C to denote corresponding components to those described above with reference to FIGS. 1-4. Accordingly, no detailed description of the same or corresponding components is provided herein with reference to FIGS. 5 and 6A-6C.

The battery cell 1000 shown in FIGS. 5 and 6A-6C differs from the cell 100 of FIGS. 1-4 in that the battery cell 1000 further includes seal regions 161-163. The seal regions 161-163 are located generally in the expansion regions 151-153 described above with reference to FIGS. 1-4. Any description or teaching provided herein with reference to the location of an expansion region 151-153 may also be equally applicable to the location of a seal region 161-163 and vice versa.

The seal regions 161-163 comprise regions in which internal surfaces of the flexible housing 101 are sealed together. For example a seal region 161-163 may comprise a sealant such as a glue and/or tape arranged to seal opposing internal surfaces of the flexible housing 101 together. Additionally or alternatively, a seal region 161-163 may be formed using heat sealing to bond internal surfaces of the flexible housing 101 together.

The seal regions 161-163 are arranged to inhibit the electrolyte 121 from leaving the electrochemical zone 103. For example, the seal regions 161-163 may be arranged to inhibit the electrolyte 121 from leaving the electrochemical zone 103 and entering the expansion regions described above. By sealing the flexible housing 101 together in the seal regions 161-163, any space available for the electrolyte 121 to move into and be exposed to low pressure conditions is reduced. Furthermore, by sealing the flexible housing 101 together in the seal regions 161-163, the flexible housing 101 may be inhibited from expanding in these regions. For example, the seal regions 161-163 may increase the rigidity of the housing 101 in these regions and may act to reduce or prevent any expansion of the housing 101. Advantageously these effects reduce the strain placed on the housing 101, thereby reducing the risk of damage to the housing 101 (such as rupture of the housing 101). Furthermore, by inhibiting the electrolyte from leaving the electrochemical zone 103, any performance degradation of the battery cell 1000 may be reduced.

Additionally, the presence of the seal regions 161-163 may further reduce the expansion of the electrolyte into any un-sealed space between the flexible housing 101 and the second regions 111b, 114b of the first and second electrodes 111, 114, (these unsealed spaces can be seen, for example, in FIGS. 3A and 3C). For example, the seal regions 161-163 may cause the flexible housing 101 to be fitted tightly around the electrodes 111, 114 and any un-sealed space may be reduced, thereby inhibiting the flow of electrolyte into a region between the flexible housing 101 and the second regions 111b, 114b of the first and second electrodes 111, 114.

As can be seen, for example in FIGS. 6A-6C, the seal regions 161-163 may serve to increase the thickness of the battery cell 1000 in these regions (relative to no sealing being provided in these regions). For example, the seal regions 161-163 may include a sealant arranged between opposing internal surfaces of the flexible housing 101 (and sealing the internal surfaces together). The volume of sealant provided in the seal regions 161-163 may be sufficient to substantially increase the thickness of the cell 1000 in these regions.

In at least some examples, an increase in the thickness of the cell 1000 in the seal regions may be sufficient to cause contact between clamping elements 201a, 201b (not shown in FIGS. 6A-6C) and the flexible housing 101 in the seal regions 161-163. A clamping force may therefore be applied in the vicinity of the seal regions 161-163 and a resulting clamping pressure may be exerted in the seal regions 161-163. That is, at least one of the seal regions 161, 162, 163 may form part of a clamping surface arranged to receive a clamping force so as to apply a clamping pressure on the electrochemical zone and/or at least one of the seal regions 161, 162, 163. Such a clamping pressure may serve to increase the pressure inside the flexible housing 101 in the vicinity of the seal regions 161-163. For example, the pressure inside the flexible housing 101 may be maintained at a pressure which is greater than a vaporisation pressure of the electrolyte 121. This may advantageously inhibit or prevent vaporisation of the electrolyte 121.

In some examples, the seal regions 161-163 may be arranged to fill substantially an entire expansion region 151-153. For example, internal surfaces of the flexible housing 101 may be sealed together throughout substantially all of the first expansion region 151, which is situated between the second regions 111b, 114b of the electrodes 111, 114. In some examples, the internal surfaces of the flexible housing 101 may be sealed together in only a portion of an expansion region 151-153. That is, a seal region 161-163 in which the flexible housing is sealed together may occupy only a portion of an expansion region 151-153. For example, a spot of sealant may be added to an expansion region 151-153 which does not fill the entire expansion region 151-153. It has been found that such an arrangement may be sufficient to inhibit expansion of the housing 101 in the expansion region 151-153 without sealing the entirety of the expansion region 151-153. Furthermore, during manufacture of a battery cell 1000, it may be more simple and easier to seal only a portion of an expansion region 151-153 as opposed to sealing substantially all of an expansion region 151-153.

It will be appreciated that in at least some examples, the sealant in the seal regions 161, 162, 163 provide a synergistic effect in conjunction with clamping of the cell 1000. For example, applying a clamping pressure to the battery cell 100 (e.g. with a clamp 201) may inhibit vaporisation of the electrolyte 121 in the electrochemical zone 103 whilst the seal regions 161, 162, 163 act to inhibit the electrolyte from leaving the electrochemical zone 103. For example, application of the clamping pressure on the electrochemical zone 103 may act to force electrolyte towards the seal regions 161, 162, 163, which might in the absence of any sealant in the seal regions 161, 162, 163 otherwise cause electrolyte to enter the seal regions 161, 162, 163 and vaporise. The presence of sealant in the seal regions 161, 162, 163 acts to inhibit electrolyte from leaving the electrochemical zone 103 (e.g. under the application of a clamping pressure) and entering the seal regions 161, 162, 163, where it might otherwise vaporise. That is, sealant in the seal regions and the application of a clamping force may work together to inhibit vaporisation of the electrolyte and expansion of the battery cell.

Furthermore, as was described above, in at least some examples, sealant in the seal regions 161, 162, 163 may increase the thickness of the seal regions such that at least one seal region 161, 162, 163 may form part of clamping surface on which a clamping pressure may be applied. Such a clamping pressure may serve to increase the pressure inside the flexible housing 101 in the vicinity of the seal regions 161-163 so as to advantageously inhibit or prevent vaporisation of the electrolyte 121 in the vicinity of the seal regions 161-163.

As was explained above, at least one seal region 161-163 may be arranged to inhibit electrolyte 121 from leaving an electrochemical zone 103 of a battery cell 1000. In general, a seal region 161-163 may be arranged between the first regions 111a, 114a of the electrodes 111, 114 and the perimeter seal. A seal region 161-163 may be arranged between the first regions 111a, 114a of the electrodes 111, 114, the perimeter seal and at least one second region 111b, 114b of an electrode 111, 114. For example, a seal region 161-163 may be generally surrounded (e.g. on four sides) by the perimeter seal 105, first regions 111a, 114a of the electrodes and at least one second region 111b, 114b of an electrode 111, 114.

For example, each of the seal regions 161-163 shown in FIGS. 5 and 6A-6C are arranged between the first regions 111a, 114a of the electrodes 111, 114, the perimeter seal 105 and at least one second region 111b, 114b of an electrode. In particular, a first seal region 161 is arranged between the first regions 111a, 114a of the electrodes 111, 114, the perimeter seal 105, the second region 111b of the first electrode 111 and the second region 114b of the second electrode 114. A second seal region 162 is arranged between the first regions 111a, 114a of the electrodes 111, 114, the second region 111b of the first electrode 111 and the perimeter seal 105. A third seal region 163 is arranged between the first regions 111a, 114a of the electrodes 111, 114, the second region 114b of the second electrode 114 and the perimeter seal 105.

In at least some examples, at least one seal region 161-163 may be arranged within an outer extent of the electrodes 111, 114. For example, the outer extent of the electrodes 111, 114 may be taken as the smallest rectangle which encompasses the entirety of the first 111 and second electrodes 114. The outer extent of the electrodes 111, 114 shown in the Figures roughly corresponds with the inner extent of the perimeter seal 105, which has generally rectangular shape. As is shown, for example, in FIG. 5 the seal regions 161-163 are arranged within the inner extent of the perimeter seal 105 and within the outer extent of the electrodes 111, 114. The seal regions 161-163 may be arranged in gaps within the outer extent of the electrodes 111, 114 in which no electrodes 111, 114 are situated. Put another way, the perimeter seal 105 may define a sealed boundary, which may, for example, be substantially rectangular. The seal regions 161-163 may be arranged in portions of the sealed boundary (e.g. a rectangle) in which no electrode 111, 114 is situated.

In general, the seal regions 161-163 may be arranged outside of the electrochemical zone 103 and within the confines of the perimeter seal 105. The seal regions 161-163 may be located in any suitable region so as to inhibit the electrolyte 121 from leaving the electrochemical zone 103.

Specific examples have been described herein in which a battery cell comprises a first electrode and a second electrode. However, as also described herein, a battery cell may comprise more than two electrodes. For example, a battery cell of the type contemplated herein may comprise a plurality of cathodes and a plurality of anodes. Descriptions and teachings presented herein in relation to a battery cell comprising two electrodes may equally apply to a battery cell comprising more than two electrodes and vice versa.

It will be appreciated that the Figures are provided merely as schematic illustrations of the apparatus disclosed herein and at least some of the Figures are not presented to scale. For example, at least of the components shown in the Figures may have dimensions which have been enlarged or reduced, relative to other components for ease of illustration and that the relative dimensions of components shown should not be construed to be limiting.

Features, integers, characteristics, compounds or materials described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples. The invention extends to any novel one, or any novel combination, of the features disclosed in this specification (including any accompanying claims, abstract and drawings), or to any novel one, or any novel combination, of the steps of any method or process so disclosed.

1. A battery cell comprising:
a flexible housing including a perimeter seal at which the housing is sealed around its perimeter;
a first and second electrode each comprising a first region and a second region protruding from the first region, wherein the first and second regions of the first and second electrodes are situated within the flexible housing;
an electrolyte situated between the first region of the first electrode and the first region of the second electrode, wherein the first regions of the first and second electrodes and the electrolyte are arranged to define an electrochemical zone housed within the flexible housing and wherein the second regions of the first and second electrodes protrude from the electrochemical zone; and
at least one seal region in which internal surfaces of the flexible housing are sealed together, wherein the at least one seal region is arranged between the first regions of the first and second electrodes and the perimeter seal and is arranged to inhibit the electrolyte from leaving the electrochemical zone.

2. The battery cell of claim 1, wherein the at least one seal region includes a seal region arranged between the first regions of the first and second electrodes, the perimeter seal and at least one second region of the first and/or second electrode.

3. The battery cell of claim 1, wherein the at least one seal region includes a seal region arranged between the second region of the first electrode and the second region of the second electrode.

4. The battery cell of claim 1, wherein the at least one seal region includes a seal region arranged between the second region of the first electrode and the perimeter seal.

5. The battery cell of claim 1, wherein the at least one seal region includes a seal region arranged between the second region of the second electrode and the perimeter seal.

6. The battery cell of claim 1, wherein the at least one seal region includes a seal region arranged within the perimeter seal and within an outer extent of the first and second electrodes.

7. The battery cell of claim 1, wherein the perimeter seal defines a sealed boundary.

8. The battery cell of claim 7, wherein the at least one seal region includes a seal region arranged within a portion of the sealed boundary in which no electrode is situated.

9. The battery cell of claim 1, wherein the second region of the first electrode is offset from the second region of the second electrode.

10. The battery cell of claim 1, wherein the at least one seal region comprises a sealant arranged in the seal region and attached to opposing internal surfaces of the flexible housing.

11. The battery cell of claim 1, wherein the first electrode and second electrode are substantially planar, and wherein the first electrode is arranged to be substantially parallel with the second electrode.

12. The battery cell of claim 1, further comprising a first contact tab electrically coupled to the second region of the first electrode and a second contact tab electrically coupled to the second electrode, wherein the first and second contact tabs extend through the perimeter seal of the flexible housing.

13. The battery cell of claim 12, wherein at least a portion of first and second tabs protrude outside of the flexible housing and comprise electrical terminals of the battery cell.

14. The battery cell of claim 1, further comprising a porous separator arranged between the first region of the first electrode and the first region of the second electrode.

15. The battery cell of claim 1, wherein the battery cell comprises a plurality of clamping surfaces arranged to receive a clamping force such that application of a clamping force on the clamping surfaces applies a clamping pressure on the electrochemical zone.

16. The battery cell of claim 15, wherein the at least one seal region are arranged to inhibit the electrolyte from leaving the electrochemical zone when a clamping force is applied to the clamping surfaces.

17. The battery cell of claim 15, wherein the at least one seal region is arranged to form part of at least one of the clamping surfaces.

18. A battery cell arrangement comprising:
at least one battery cell according to claim 15; and
a clamp arranged to apply a clamping force to the clamping surfaces of the at least one battery cell.

19. The battery cell arrangement of claim 18, wherein the clamp comprises a first and second clamping element arranged on opposing sides of the at least one battery cell and a clamping device arranged to force the first and second clamping elements to exert a clamping force on the at least one battery cell.

20. The battery cell arrangement of claim 19, wherein the clamping device is arranged to retain the first and second clamping elements in fixed relation to each other.

21. The battery cell arrangement of claim 19, wherein the clamping device is arranged to urge the first and second clamping elements towards each other.

22. The battery cell arrangement of claim 18, wherein the clamp is arranged to apply a uniaxial pressure to the clamping surfaces.

23. The battery cell arrangement of claim 18, wherein the clamp is arranged to apply a clamping force sufficient to inhibit vaporisation of the electrolyte.

24. The battery cell arrangement of claim 23, wherein the clamp is arranged to apply a clamping pressure which is substantially equal to or greater than a difference between the vapour pressure of the electrolyte and atmospheric pressure to which the battery cell is exposed.

25. A method for clamping at least one battery cell according to any claim 15, the method comprising:
applying a clamping force to the clamping surfaces of the at least one battery cell.

26. The method of claim 25, wherein the clamping force is applied on opposing sides of the at least one battery cell.

27. The method of claim 25, wherein applying the clamping force comprises applying a uniaxial pressure to the clamping surfaces.

28. The method of claim 25, wherein the applied clamping force is sufficient to inhibit vaporisation of the electrolyte.

29. The method of claim 25, wherein the applied clamping force is such that a clamping pressure applied is substantially equal to or greater than a difference between the vapour pressure of the electrolyte and an atmospheric pressure to which the battery cell is exposed.
